(19) United States
(12) Patent Application Publication
(10) Pub. No.: US 2008/0289501 A1
(43) Pub. Date: Nov. 27, 2008

(54) Emission Control Systems

(76) Inventor: Kosta Kapitoures, Queensland (AU)

Correspondence Address: ABELMAN, FRAYNE & SCHWAB, 666 THIRD AVENUE, 10TH FLOOR, NEW YORK, NY, 10017, US

(21) Appl. No.: 11/660,564

(22) PCT Filed: Aug. 23, 2005
(86) PCT No.: PCT/AU05/01263

§ 371 Date: Aug. 14, 2007

(30) Foreign Application Priority Data
Aug. 31, 2004 (AU) 2004205336

(51) Int. Cl. F23J 15/04; B01D 53/18; B01D 47/14; F01N 3/04

(52) U.S. Cl. 95/211; 96/274

(57) ABSTRACT

A separation column (12) for an emission control system, the column including: an exhaust gas inlet (41) for receiving polluted exhaust gases therethrough; a first packed bed (37) at a predetermined first level above said exhaust gas inlet; first liquid distribution means (39) above said first packed bed for distributing liquid onto said first packed bed; a second packed bed (38) at a predetermined second level below said exhaust gas inlet; second liquid distribution (40) means below said first packed bed and above said second packed bed for distributing liquid onto said second packed bed; cooling means (46) between said second liquid distribution means and said second packed bed for cooling liquid from said second distribution means and entrained exhaust gases; an exhaust gas outlet (35) above said first packed bed for discharging cleaned exhaust gases therethrough; and a contaminated liquid outlet (36) below said second packed bed.

### FIELD OF THE INVENTION

This invention relates to emission control systems. The invention has particular application to controlling the emission of pollutants but may have application in other fields.

International patent application No. PCT/AU01/01028 by the present inventor describes an emission control system for use in separating pollutants from exhaust gases in which the exhaust gases pass upwards through a column having a packed bed of expanded mesh while low temperature water is sprayed onto the filter bed from above. It is believed that such a system relies on the low temperature water to cause some gaseous pollutants to condense while others become entrained whereupon they can be separated from the water by a filtration system. However, the cost of building and maintaining such a system for separating pollutants from very large exhaust gas flows, for example from power stations and other large industrial facilities, appears to be prohibitive at present.

The present invention is aimed at providing an emission control system which utilizes at least some of the advantages of the system described in the aforementioned application but which can be satisfactorily used with large exhaust gas flows. Thus, the present invention provides a system having a separation chamber of greater flow capacity. The invention also provides a system including a pre-cooling chamber in which the temperature of the exhaust gases is reduced prior to entry to the separation chamber while maintaining them in a suitable state for separation of the pollutants.

### SUMMARY OF THE INVENTION

With the foregoing in view, the invention in one aspect resides broadly in a separation column for an emission control system, the column including:

an exhaust gas inlet for receiving polluted exhaust gases therethrough;

a first packed bed at a predetermined first level above said exhaust gas inlet;

first liquid distribution means above said first packed bed for distributing liquid onto said first packed bed;

a second packed bed at a predetermined second level below said exhaust gas inlet;

second liquid distribution means below said first packed bed and above said second packed bed for distributing liquid onto said second packed bed; and

an exhaust gas outlet above said first packed bed for discharging cleaned exhaust gases therethrough.

In another aspect the invention resides broadly in a separation column for an emission control system, the column including:

an exhaust gas inlet for receiving polluted exhaust gases therethrough;

a first packed bed at a predetermined first level above said exhaust gas inlet;

first liquid distribution means above said first packed bed for distributing liquid onto said first packed bed;

a second packed bed at a predetermined second level below said exhaust gas inlet;

second liquid distribution means below said first packed bed and above said second packed bed for distributing liquid onto said second packed bed;

cooling means between said second liquid distribution means and said second packed bed for cooling liquid from said second distribution means and entrained exhaust gases;

an exhaust gas outlet above said first packed bed for discharging cleaned exhaust gases therethrough; and

a contaminated liquid outlet below said second packed bed.

In another aspect the invention resides broadly in a separation column for an emission control system, including:

an exhaust gas inlet for receiving polluted exhaust gases therethrough;

a first packed bed at a predetermined first level above said exhaust gas inlet;

first liquid distribution means above said first packed bed for distributing liquid onto said first packed bed;

a second packed bed at a predetermined second level below said exhaust gas inlet;

second liquid distribution means below said first packed bed and above said second packed bed for distributing liquid onto said second packed bed;

cooling means between said exhaust gas inlet and said second packed bed for cooling exhaust gases entering said column through said exhaust gas inlet;

an exhaust gas outlet above said first packed bed for discharging cleaned exhaust gases therethrough; and

a contaminated liquid outlet below said second packed bed.

In another aspect the invention resides broadly in an emission control system, including:

a separation column as previously described;

a pre-cooler having a cooling chamber with a hot exhaust gas inlet for receiving polluted exhaust gases therethrough and an exhaust gas outlet in fluid communication with the exhaust gas inlet of said separation column, and cooling means for cooling hot exhaust gases as they flow through said cooling chamber.

Preferably, the emission control system includes a mixer for mixing liquid with the polluted exhaust gases prior to entry to said separation column. In a preferred form the mixer is arranged to mix liquid with the exhaust gases downstream of the cooling chamber, that is, after they have been pre-cooled as they flow through said cooling chamber.

In another aspect the invention resides broadly in an emission control system, including:

a pre-cooler having a cooling chamber with a hot exhaust gas inlet for receiving polluted hot exhaust gases therethrough and an exhaust gas outlet;

cooling means for cooling hot exhaust gases as they flow through said cooling chamber; and

a separation column including;

an exhaust gas inlet in fluid communication with the exhaust gas outlet of said separation column for receiving polluted exhaust gases therethrough;

a first packed bed at a predetermined first level above said exhaust gas inlet;

first liquid distribution means above said first packed bed for distributing liquid onto said first packed bed;

a second packed bed at a predetermined second level below said exhaust gas inlet;

second liquid distribution means below said first packed bed and above said second packed bed for distributing liquid onto said second packed bed;

cooling means between said exhaust gas inlet and said second packed bed for cooling exhaust gases and vapor entering said column through said exhaust gas inlet;

an exhaust gas outlet above said first packed bed for discharging cleaned exhaust gases therethrough; and

a contaminated liquid outlet below said second packed bed.

Preferably, the system includes a mixer for mixing liquid with the polluted exhaust gases prior to entry to said separation column.

In another aspect the invention resides broadly in a method of controlling the emission of pollutants, including:

cooling hot exhaust gases to a predetermined temperature;

introducing the cooled exhaust gases into a separation column of the type previously described through its exhaust gas inlet; and

distributing liquid onto the first and second packed beds in the separation column.

Preferably, the liquid distributed by said first and second distribution means and by said mixer is water or water containing additives selected to suit the conditions and characteristics of the exhaust gases being cleaned.

Preferably, the cooling means is maintained at a temperature of less than about 5 degrees Celsius but more preferably less than about 2 degrees Celsius.

Preferably, the method also includes mixing liquid with the exhaust gases prior to introduction to the separation chamber and more preferably after the exhaust gases have been cooled to said predetermined temperature.

Preferably, the cooling chamber of the pre-cooler is cooled by application of a cooling medium, typically water, onto the walls of the housing defining the chamber thus reducing the temperature of the exhaust gases by heat transfer through the walls. The cooling water may be recycled through a cooling tower or other suitable apparatus or discharged to a lake or the like. Preferably, the exhaust gases are pre-cooled to a temperature which is substantially less demanding on the liquid being distributed to the first and second packed beds from the perspective of transfer of heat thereto but leaves sufficient heat in the exhaust gases for the separation column to work effectively. In a preferred form, the pre-cooler and the separation chamber are selected for the specified exhaust gas flow characteristics which result in the temperature in the separation column above the first packed bed being between about 2 degrees Celsius and about 190 degrees Celsius. In a more preferred form the temperature is between about 2 degrees Celsius and about 40 degrees Celsius.

Preferably, the packed beds are packed with a metal foil mesh of the type described in the international application by the present applicant mentioned earlier which is incorporated herein by reference.

Preferably, liquid being distributed by the first and second liquid distribution means is less than about 5 degrees Celsius but preferably it is about 2 degrees Celsius. Similarly, it is preferred that the liquid being mixed with the hot exhaust gases is also less than about 5 degrees Celsius but preferably about 2 degrees Celsius.

### BRIEF DESCRIPTION OF THE DRAWING

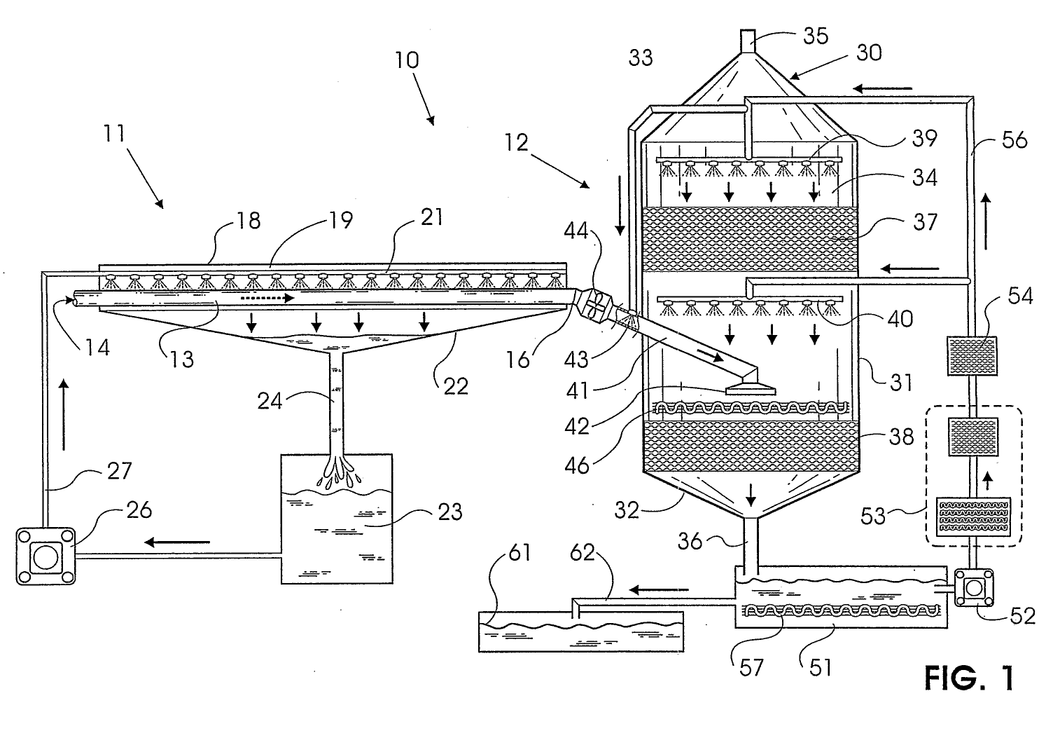

In order that the invention may be more easily understood and put into practical effect, reference will now be made to FIG. 1 which is a schematic diagram of an emission control system according to the present invention.

### DETAILED DESCRIPTION OF THE DRAWING

The emission control system 10 illustrated in FIG. 1 is intended for use with a small electric power station but could be used with various other industrial facilities where hot exhaust gases are typically discharged to atmosphere, for example, boiler houses, kilns, foundries or engines.

The system has two main components, a pre-cooler 11 and a separation column 12 as well as numerous other items of associated equipment which will be described later.

The pre-cooler includes an inner pipe 13 having an inlet 14 at one end through which hot exhaust gases and entrained particles exhausted by the power station (or other facility) enter the pre-cooler, and an outlet 16 at the other end through which the pre-cooled exhaust gases are discharged for entry to the separation chamber as will be described later, the pipe forming a flow through pre-cooling chamber in which the exhaust gas is cooled as it flows therethrough from one end to the other. The inner pipe is supported within an outer pipe 18 which forms a wetting chamber 19 within which water can be sprinkled or otherwise distributed onto the outer face of the inner pipe for removing heat therefrom. For that purpose, a sprinkler system 21 is mounted in the outer pipe and arranged to continuously spray water onto the outer face of the inner pipe while hot exhaust gases are flowing therethrough to effectively transfer heat from the inner pipe and in turn from the hot exhaust gases to the water. Suitably, the outer pipe has a plurality of drains along its lower portion through which the heated water drains to a collector 22 depending from the outer pipe along its length and from there to a storage reservoir 23 via a drain pipe 24. However, the outer pipe and collector can be constructed as a unitary housing creating an open wetting chamber with the inner pipe mounted on suitable stands or the like if desired. Water from the reservoir is continuously recycled through the sprinkler system by a pump 26 and delivery pipe 27. If necessary, the water from the reservoir 23 can be diverted to a cooling tower or other suitable cooling device.

The separation column 12 includes a housing 30 comprising a generally cylindrical main body 31, a conical base 32 and a conical top 33 contiguous therewith which together define a chamber 34 in which separation of gaseous and particulate pollutants from exhaust gases takes place. A cleaned exhaust gas outlet 35 is provided at the apex of the conical top and a contaminated water outlet 36 is provided at the apex of the conical base.

A first packed bed 37 is supported in the upper half of the separation chamber and a second packed bed 38 is supported in the lower half, spaced from the first packed bed. Suitably, the beds are packed with expanded metal foil of the type described in the international application by the present applicant mentioned earlier but other forms of expanded metal foil may be used although possibly to lesser effect. An upper sprinkler system 39 is supported in the separation chamber above the first packed bed and is adapted to sprinkle chilled water at about 2 degrees Celsius onto the first packed bed. Similarly, a lower sprinkler system 40 is supported in the separation chamber above the second packed bed but below the first packed bed and is adapted to sprinkle chilled water at about 2 degrees Celsius onto the second packed bed.

Pre-cooled exhaust gases from the pre-cooler 11 enter the separation chamber 34 via exhaust gas inlet pipe 41 which is connected to the inner pipe 13 of the pre-cooler at one end and extends through the cylindrical wall 31 of the separation column and terminates centrally of the separation chamber in a downwardly directed opening 42. A pre-entry sprinkler system 43 is supported in the exhaust gas inlet pipe between the pre-cooler and the separation column for mixing chilled water at about 2° C. with the pre-cooled exhaust gases prior to entry to the separation chamber. A fan 44 is also mounted in the inlet pipe upstream of the pre-entry sprinkler system to ensure positive flow in the inlet pipe at all times.

A heat exchanger 46 is supported in the separation chamber between the downwardly directed opening 42 and the second packed bed and is also supplied with chilled water at about 2° C. The heat exchanger is intended to reduce the temperature of the gases immediately above the second packed bed as well as the temperature of contaminated water falling from the upper and lower sprinkler systems which pass over it.

Water for the upper and lower sprinkler systems and the pre-entry sprinkler system is obtained from a reservoir (or tank) 51 and is pumped to the various sprinkler systems by a pump 52 via a multistage filter system 53 and a chiller unit 54 and then through pipe network 56 to the respective sprinkler systems. Water within the reservoir is also cooled by a heat exchanger 57 mounted in the reservoir.

In use, the pre-cooling pipe of the pre-cooler is connected to the exhaust gas outlet of the power station, engine or other facility and hot exhaust gases containing pollutants in gaseous and particulate form pass through the pre-cooling pipe thereby being cooled by the sprinkler system 21. After exiting the pre-cooler, the pre-cooled exhaust gases are mixed with chilled water entering the inlet pipe 41 via a sprinkler system 43 and then the pre-cooled and pre-wetted exhaust gases enter the separation chamber immediately above the heat exchanger 46. The hot exhaust gases rise upwards while chilled water sprays downwards from the lower sprinkler system 39 entraining some of the pollutants and falls down over the heat exchanger 46 between its coils and thence through the lower packed bed 37. Exhaust gases continuing to rise move upwards through the first packed bed where more pollutants become entrained in chilled water flowing through the upper packed bed from the upper sprinkler system. The pre-cooler and the separation chamber are selected to suit the exhaust gas flow characteristics of the facility to which the emission control system is to be connected which result in the temperature in the separation column above the first packed bed being hotter than the chilled water entering the separation chamber through the upper and lower sprinkler systems, that is, typically hotter than 2 degrees Celsius.

Water and entrained pollutants pass out of the separation chamber through drain pipe 58 which is connected to the conical outlet 36 in the conical base 32 and thence into the chilled water reservoir 51. Meanwhile, cleaned exhaust gases exit the separation chamber through exhaust outlet 35 in the conical top.

Liquid and solid pollutants build up in the reservoir 51 and are drawn off intermittently as required to a sludge tank 61 through pipe 62. However, in large installations, the pollutants may be drawn off continuously.

The foregoing description has been given by way of illustrative example of the invention and many modifications and variations which will be apparent to persons skilled in the art may be made without departing from the spirit and scope of the invention as defined in the appended claims.

1. A separation column for an emission control system, the column including: an exhaust gas inlet for receiving polluted exhaust gases therethrough; a first packed bed at a predetermined first level above said exhaust gas inlet; first liquid distribution means above said first packed bed for distributing liquid onto said first packed bed; a second packed bed at a predetermined second level below said exhaust gas inlet; second liquid distribution means below said first packed bed and above said second packed bed for distributing liquid onto said second packed bed; cooling means between said second liquid distribution means and said second packed bed for cooling liquid from said second distribution means and entrained exhaust gases; an exhaust gas outlet above said first packed bed for discharging cleaned exhaust gases therethrough; and a contaminated liquid outlet below said second packed bed.

2. A separation column for an emission control system, including: an exhaust gas inlet for receiving polluted exhaust gases therethrough; a first packed bed at a predetermined first level above said exhaust gas inlet; first liquid distribution means above said first packed bed for distributing liquid onto said first packed bed; a second packed bed at a predetermined second level below said exhaust gas inlet; second liquid distribution means below said first packed bed and above said second packed bed for distributing liquid onto said second packed bed; cooling means between said exhaust gas inlet and said second packed bed for cooling exhaust gases entering said column through said exhaust gas inlet; an exhaust gas outlet above said first packed bed for discharging cleaned exhaust gases therethrough; and a contaminated liquid outlet below said second packed bed.

3. A separation column according to claim 1, wherein said exhaust gas inlet is arranged to direct exhaust gases onto said cooling means.

4. A separation column according to claim 1, wherein said first and second packed beds are packed with expanded metal foil.

5. An emission control system, including: a separation column, an exhaust gas inlet for receiving polluted exhaust gases therethrough; a first packed bed at a predetermined first level above said exhaust gas inlet; first liquid distribution means above said first packed bed for distributing liquid onto said first packed bed; a second packed bed at a predetermined second level below said exhaust gas inlet; second liquid distribution means below said first packed bed and above said second packed bed for distributing liquid onto said second packed bed; cooling means between said second liquid distribution means and said second packed bed for cooling liquid from said second distribution means and entrained exhaust gases; an exhaust gas outlet above said first packed bed for discharging cleaned exhaust gases therethrough; a contaminated liquid outlet below said second packed bed; a pre-cooler having a cooling chamber with a hot exhaust gas inlet for receiving polluted exhaust gases therethrough and an exhaust gas outlet in fluid communication with the exhaust gas inlet of said separation column, and cooling means for cooling hot exhaust gases as they flow through said cooling chamber.

6. An emission control system, including: a pre-cooler having a cooling chamber with a hot exhaust gas inlet for receiving polluted hot exhaust gases therethrough and an exhaust gas outlet; cooling means for cooling hot exhaust gases as they flow through said cooling chamber; and a separation column including; an exhaust gas inlet in fluid communication with the exhaust gas outlet of said separation column for receiving polluted exhaust gases therethrough; a first packed bed at a predetermined first level above said exhaust gas inlet; first liquid distribution means above said first packed bed for distributing liquid onto said first packed bed; a second packed bed at a predetermined second level below said exhaust gas inlet; second liquid distribution means below said first packed bed and above said second packed bed for distributing liquid onto said second packed bed; cooling means between said exhaust gas inlet and said second packed bed for cooling exhaust gases and liquid vapor entering said column through said exhaust gas inlet; an exhaust gas outlet above said first packed bed for discharging cleaned exhaust gases therethrough; and a contaminated liquid outlet.

7. An emission control system according to claim 5, including a mixer for mixing liquid with the polluted exhaust gases prior to entry to said separation column.

8. An emission control system according to claim 7, wherein said mixer is arranged to mix liquid with the polluted exhaust gases downstream of said cooling chamber.

9. A method of controlling the emission of pollutants, including: providing a separation column having an exhaust gas inlet for receiving polluted exhaust gases therethrough; a first packed bed at a predetermined first level above said exhaust gas inlet; first liquid distribution means above said first packed bed for distributing liquid onto said first packed bed; a second packed bed at a predetermined second level below said exhaust gas inlet; second liquid distribution means below said first packed bed and above said second packed bed for distributing liquid onto said second packed bed; cooling means between said second liquid distribution means and said second packed bed for cooling liquid from said second distribution means and entrained exhaust gases; an exhaust gas outlet above said first packed bed for discharging cleaned exhaust gases therethrough; and a contaminated liquid outlet below said second packed bed; cooling hot exhaust gases to a predetermined temperature; introducing the cooled exhaust gases into said separation column through its exhaust gas inlet; and distributing liquid onto the first and second packed beds in the separation column.

10. A method according to claim 9, including maintaining the cooling means at a temperature of less than about 5 degrees Celsius.

11. A method according to claim 9, including maintaining the cooling means at a temperature of less than about 2 degrees Celsius.

12. A method according to claim 9, including mixing liquid with the exhaust gases prior to introduction to the separation chamber.

13. A method according to claim 12, wherein the liquid is mixed with the exhaust gases after they have been cooled to said predetermined temperature.

14. A method according to claim 9, wherein the cooling chamber of the pre-cooler is cooled by application of liquid onto the housing defining the chamber.

15. A method according to claim 9, wherein said predetermined temperature results in the temperature of gases above said first liquid distribution means being between about 2 degrees Celsius and about 190 degrees Celsius.

16. A method according to claim 9, wherein said pre-cooler and said separation column are selected for specified exhaust gas characteristics which result in the temperature in the separation column above the first packed bed being between about 2 degrees Celsius and about 190 degrees Celsius.

17. A method according to claim 9, wherein said pre-cooler and said separation column are selected for specified exhaust gas characteristics which result in the temperature in the separation column above the first packed bed being between about 2 degrees Celsius and about 40 degrees Celsius.

18. A method according to claim 9, wherein liquid being distributed by the first and second liquid distribution means is less than about degrees Celsius.

19. A method according to claim 9, wherein liquid being distributed by the first and second liquid distribution means is less than about 2 degrees Celsius.

20. A method according to claim 9, wherein liquid being mixed with the hot exhaust gases is less than about 5 degrees Celsius.

21. A separation column for an emission control system, the column including: an exhaust gas inlet for receiving polluted exhaust gases therethrough; a first packed bed at a predetermined first level above said exhaust gas inlet; first liquid distribution means above said first packed bed for distributing liquid onto said first packed bed; a second packed bed at a predetermined second level below said exhaust gas inlet; second liquid distribution means below said first packed bed and above said second packed bed for distributing liquid onto said second packed bed; and an exhaust gas outlet above said first packed bed for discharging cleaned exhaust gases therethrough.

22. A method of controlling the emission of pollutants according to claim 9 wherein the liquid is water or water which contains additives.

23. A method of controlling the emission of pollutants according to any of the preceding claims wherein the liquid is water which contains additives.

24. A separation column as hereinbefore described with reference to the accompanying drawings.

25. An emission control system as hereinbefore described with reference to the accompanying drawings.

26. A method of controlling the emission of pollutants as hereinbefore described with reference to the accompanying drawings.
